(19) United States
(12) Patent Application Publication
(10) Pub. No.: US 2020/0039646 A1
(43) Pub. Date: Feb. 6, 2020

(54) Flying Gyroscope System and Method

(71) Applicants: Mark Fuller, Sun Valley, CA (US); Dezso Molnar, Sun Valley, CA (US); James Doyle, Sun Valley, CA (US); John Canavan, Sun Valley, CA (US)

(72) Inventors: Mark Fuller, Sun Valley, CA (US); Dezso Molnar, Sun Valley, CA (US); James Doyle, Sun Valley, CA (US); John Canavan, Sun Valley, CA (US)

(21) Appl. No.: 16/531,064

(22) Filed: Aug. 4, 2019

Related U.S. Application Data
(60) Provisional application No. 62/715,271, filed on Aug. 6, 2018.

(51) Int. Cl. B64C 39/06; B64C 39/02

(52) U.S. Cl. CPC B64C 39/062; B64C 39/02

(57) ABSTRACT

A system for providing a flying craft is disclosed. The craft may include gyroscopes for stability, and rotor blades and/or chambers of lighter-than-air gasses for lift. The craft may be equipped with payloads such as lights, water delivery devices, speaker, wireless power systems and other payloads.

### CROSS-REFERENCE TO RELATED APPLICATION

This application claims the benefit of U.S. Provisional Application No. 62/715,271, filed Aug. 6, 2018, the contents of which are incorporated herein by reference.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to a craft that flies. More particularly, this invention relates to systems and methods of a flying craft that includes gyroscopes and rotor blades.

### BACKGROUND OF THE INVENTION

Large and oversized art installations have become an important part of modern pop culture. Some of the installations are purely aesthetic while others may include beneficial functionalities (such as very large industrial ceiling fans). However, the installations are mostly static.

Accordingly, there is a need for innovative installations that may fly while including artistic elements of light, sound and water.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1-3 show aspects of a system according to exemplary embodiments hereof.

### DETAILED DESCRIPTION OF THE PREFERRED EMBODIMENTS

The term “mechanism,” as used herein, refers to any device(s), process(es), service(s), or combination thereof. A mechanism may be implemented in hardware, software, firmware, using a special-purpose device, or any combination thereof. A mechanism may be mechanical or electrical or a combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

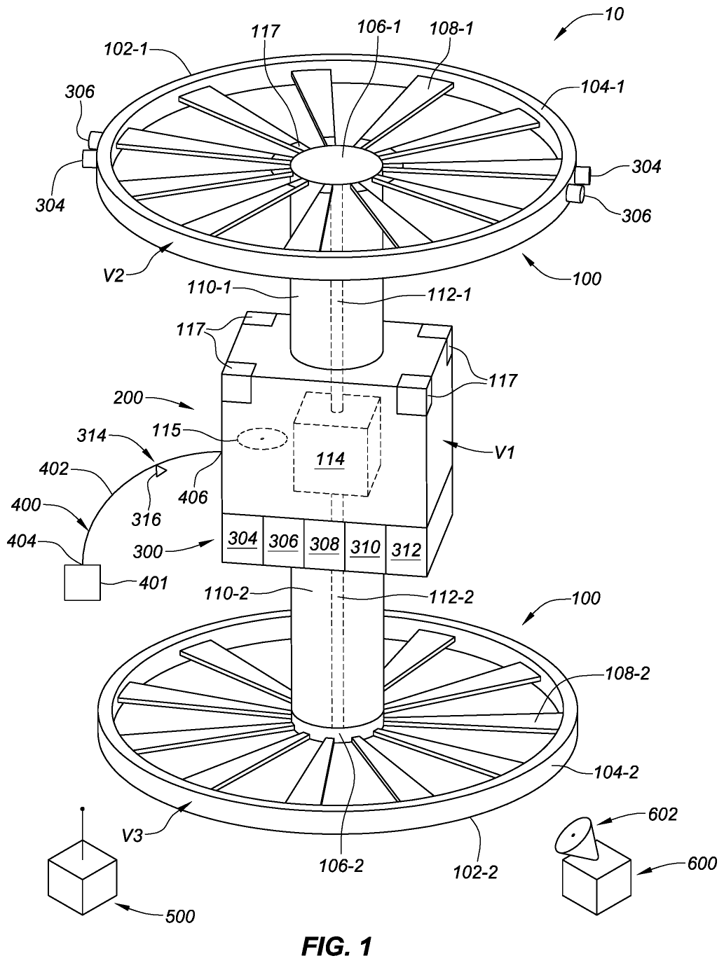

A system 10 according to exemplary embodiments hereof is described with reference to the drawing in FIGS. 1-3. In general, the system 10 may include at least one spinning wheel configured with radial rotor blades. One preferable implementation may include at least two spinning wheels with a craft, vehicle or body configured between the wheels. The rotor blades configured with each wheel may spin to provide lift to the system 10 and/or to affect its direction of flight. The spinning wheels may also provide gyroscopic precession to the system. The system may also include compartments that include lighter-than-air gasses that may also provide lift to the system.

As shown in FIG. 1, in one exemplary embodiment hereof, the system 10 may include a wheel assembly 100, a body assembly 200, a payload assembly 300, a tether system 400, a control system 500, a power system 600 and other systems, elements, mechanisms and components that may be required by the system 10 as described in other sections. The payload assembly 300 may include various payloads 302 such as lights, water delivery devices, speakers and other payloads.

For the purposes of this specification, the general combination of the wheel assembly 100, the body assembly 200 and the payload assembly 300 may be referred to as the craft 12. It is understood that the system 10 may include one or more crafts 12, and that the crafts 12 need not match in their configurations of their respective wheel assemblies 100, body assemblies 200 and/or payload assemblies 300.

The system 10 may be implemented outdoors or indoors. In some preferred embodiments the craft 12 may be somewhat large such that for indoor implementation, large spaces with tall ceilings may be preferred.

The system 10 may be utilized as a standalone system, may be utilized to complement and/or integrate with other systems such as displays, or any combination thereof. For example, the system 10 may be utilized to provide lighting and/or additional airborne water streams to complement a ground based water display.

### Wheel, Body and Payload Assemblies

In one preferred implementation as shown, the wheel assembly 100 may include two opposing wheels 102-1, 102-2 separated by a distance. The wheels 102-1, 102-2 may be aligned along their central axis. While FIG. 1 depicts two wheels 102, the wheel assembly 100 may include any number of wheels 102-1, 102-2, 102-3, . . . 102-n (individually or collectively 102). The wheels 102 need not have the same diameter, width, height, or form.

The upper wheel 102-1 may include an outer wheel body 104-1 concentrically positioned around a central rotator 106-1. The central rotator 106-1 may be configured with the outer wheel body 104-1 by rotor blades 108-1 that may extend radially from the central rotator 106-1 to the outer wheel body 104-1. In this way, as the central rotator 106-1 may spin, the rotor blades 108-1 and the outer wheel body 104-1 may also spin. Similarly, the lower wheel 102-2 may include an outer wheel body 104-2 that may be configured with a central rotator 106-2 and radial rotor blades 108-2. The rotors blades 108-1 and 108-2 need not match in the size, shape, configuration, type or number of blades. In addition, the rotor blades 108-1 and 108-2 may spin in any direction, and the directions that each rotor blades 108-1, 108-2 spin need not match. In one implementation, the number of rotor blades 108-1, 108-2 configured with each wheel 102 may be twelve or more, but other numbers of rotor blades 108-1, 108-2 may also be used.

The central rotator 106-1 may be configured with a wheel support 110-1 that may generally extend downward, and the central rotator 106-2 may be configured with a wheel support 110-2 that may generally extend upward. Other types of wheel supports in other orientations may also be used. The wheel supports 110-1, 110-2 may each include drive shafts 112-1, 112-2 respectively that may provide the rotational drive to the central rotators 106-1, 106-2. Each drive shaft 112-1, 112-2 (individually or in combination) may be configured with a motor 114 that may provide the rotational drive to the drive shafts 110-1, 110-2. As the wheels 102 are spun, the rotor blades 108-1, 108-2 may provide lift to the craft 12. Note that it may be preferable for the motor 114 to spin the wheels 102-1, 102-2 in opposite directions, but it is understood that the motor 114 may spin each wheel 102 in any direction as required.

The system 10 may include a body assembly 200 that may generally be positioned and configured between the opposing wheels 102-1 and 102-2. As shown, the body assembly 200 may be positioned and generally configured between the lower end of the wheel support 110-1 and the upper end of the wheel support 110-2. The body assembly 200 may provide support to the motor 114 and other components and elements required by the system 10. The body assembly 200 may also provide support to one or more payloads 302 (described below).

The body assembly 200 may also include a chamber or volume V1 of lighter-than-air gas. It may be preferable that the volume V1 be separated from the other components within the body assembly (e.g. the motor 114). The lighter-than-air gas may include helium or any other gas or combinations of gasses that may have average densities that may be lower than that of air. It may be preferable that the volume V1 of the lighter-than-air gas be large enough such that the body assembly 200 may be buoyant in the air in which it is located. In this way, the body assembly 200 may float. Note however that the volume V1 of lighter-than-air gas may not necessarily be large enough for the body assembly 200 to float, but may still reduce the average overall density of the body assembly 200 and the components within it.

The outer wheel bodies 104-1 and 104-2 may include inner volumes V2, V3 respectively that may also include lighter-than-air gasses. It may be preferable that volumes V2 and V3 extend around the full circle of the outer wheel bodies and that the lift that the lighter-than-gas may provide to the outer wheel bodies 104-1, 104-2 may be symmetrical. However, it is understood that the volumes V2 and V3 may include sections about the circle of the wheel bodies 104-1, 104-2 and that the lift may be symmetrical or non-symmetrical. In any event, it may be preferable that the lighter-than-gas contained within the outer wheel bodies 104-1, 104-2 may reduce the average overall density of the system 10.

In one exemplary embodiment hereof, it may be preferable that the mass of the outer wheel bodies 104-1, 104-2 be large enough so that the spinning wheels 102-1, 102-2 may act as gyroscopes. In this way, the gyroscopic precession of the wheels 102-1, 102-2 may provide an inherent stability to the craft 12.

The diameters of the wheels 102-1, 102-2 may be any dimension as required by the system 10. In some preferred implementations, the diameter of the wheels 102-1, 102-2 may be up to twenty feet, fifty feet, one hundred feet or greater.

The craft 12 may also include an internal gyroscope 115 that may be used to offset the balance of the craft 12. In this way, the direction of the craft 12 may be affected (steered). For example, the internal gyroscope 115 may be a high speed gyroscope 115 that may be moved side-to-side and/or at different angles, and this movement may tilt the craft 12. Upon tilting, the spinning rotor blades 108-1, 108-2 may apply thrust in offset directions to effectively steer the craft 12.

In addition, each rotor blade 108-1, 108-2 may be rotatable along their longitudinal axis (defined as the radial direction from the central rotators 106-1, 106-2 to the wheel bodies 104-1, 104-2). In addition, each rotor blade 108-1, 108-2 may also include at least one control mechanism 117 (e.g., servomechanism 117 also referred to as servos 117), that may adjust the longitudinal angles of the blades 108-1, 108-2 in real time or otherwise. This control may be used to steer the craft 12. For example, the control mechanisms 117 may increase the angle of attack of the rotor blades 108-1, 108-2 during one half of each rotation of the wheels 102, and decrease the angle of attack during the other half of each rotation. In this way, the lift provided by the spinning wheels 102 may not be symmetrical and may be larger on the side with the increased rotor attack angles. As a result, this may cause the craft 12 to move in the direction opposite the increased thrust.

The craft 12 may also include thrusters 117 to provide control of the direction of movement (steering) and/or the orientation of the craft 12. The thrusters 117 may preferably be configured in pairs, with one pair at the bow and one pair at the stern of the craft 12. However, the thrusters 117 may be configured in any numbers in any location on the craft 12. Lifting thrusters directed downwardly may also be utilized to affect the altitude of the craft 12.

The payload assembly 300 may include different types of payloads 302 such as high intensity lights 304 (e.g., LEDs), water delivery devices 306 (e.g., Shooters®), wireless power receiving systems 308, sound devices 310 (e.g., speakers/transducers) and sound cancellation devices 312. Other types of payloads 302 may also be utilized. For example, the craft 12 may include projectors and be utilized as a floating movie projector. In another example, the craft may carry banners or signs (passive or active with lights) to be read by spectators below.

The payloads 302 may be configured with the body assemblies 200, with the wheel assemblies 100 or any combination thereof. For example, one or more lights 304 may be configured on the outer circumference of the wheels 102-1, 102-2 such that they may illuminate the round form of the wheels as viewed from below. This may present the vision of a flying Ferris wheel. The lights 304 may also shine outward from these positions and the beams of light may appear as laser beams of light extending outward from the wheels 102-1, 102-2.

In another example, the lights 304 may be configured with the body assembly 200 (or any other location on the craft 12) and be aimed at particular targets such as water displays and their associated water streams, unmanned aircraft systems (UASs) and their payloads and/or emitted water streams, buildings, statues and other structures. The lights 304 may also be used to illuminate the water streams emitted by the craft 12 itself.

The water delivery devices 306 may include any type of device that may shoot or otherwise emit water such as water nozzles, Shooters®, water jets, or other types of water delivery devices 306. Each craft 12 may include multiple water delivery devices 306, and more than one type of the water delivery devices 306 and the types need not match. Any type of water stream, such as laminar streams, water droplets or other shapes or forms of water may be emitted. The water delivery devices 306 may be configured on the outer circumference of the wheels 102-1, 102-2 such that they may emit water streams outward from these positions. In this example, the emitted water streams may appear as liquid tentacles. In another example, the water delivery devices 306 may be configured with the body assembly 200 or in any other location on the craft 12.

The water delivery device 306 may also include lights 312 that may be positioned to launch light into the streams and/or droplets of water that may be emitted. In this way, the water streams and/or droplets may be illuminated as they launch from the water devices 306. In one preferred implementation, the lights 312 may be LEDs configured with optical fibers that may transmit the light into the water streams and/or droplets from the water delivery device 306. The lights 312 may transmit white light, colored light or any combination thereof.

In one exemplary embodiment hereof, the power station 600 may include a wireless power transmission system 602 and the wireless power receiving system 308 may receive wireless power from the station 602. The wireless transmission system 602 may broadcast or generally emit beams or patterns of electromagnetic energy (e.g., microwave energy) that may be received by the craft 12 and converted to electricity. The craft 12 may include the devices necessary to receive the wireless power and convert it to electricity for use by its systems. For example, the craft 12 may include one or more rectennas 309 to collect the wireless power, rectification circuits to convert the AC to DC, collectors to feed the electricity to the systems to be powered, as well as any other devices, components or elements that may be required.

The one or more rectennas 309 may be configured with the craft 12 in any way. For example, as shown in FIG. 3, the rectenna 309 may be configured with and/or below the wheel 102-2. In this way, the rectennas 309 may be positioned to receive wireless power transmissions from below. It may be preferable that the rectennas 309 not rotate but this may not be required. The rectennas 309 may also be configured with the body assembly 200, with the wheel 102-1, or any combination thereof.

Some or all of the systems, aspects or elements of the crafts 12 may be powered by the wireless power transmission systems 602. For example, the propulsion system (e.g., the motors 114), the lights 304, the water delivery devices 306, the wireless power receiving systems 308, the sound systems 310, the sound cancellation systems 312, the communications receiver/transmitter or any other systems and/or components of the craft 12 that may require power. In this way, the crafts 12 may not be required to carry an onboard power supply such as a battery. Given that onboard power supplies may be heavy, removing the need to carry an onboard power supply may allow the crafts 12 to more easily maneuver, to carry other payloads instead, to require less energy to fly, to have longer flights as well as other benefits.

### Tether Assembly

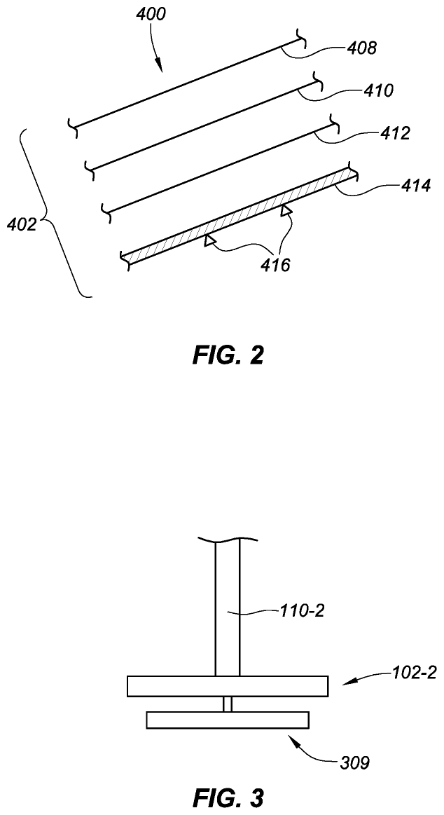

As shown in FIGS. 1 and 2, the system 10 may include a tether system 400 that may include at least one tether 402 that may extend from a tether station 401 to the craft 12. The tether station 401 may include a ground station, a station that may be configured with a moving vehicle (e.g., a ground based vehicle, a water based vehicle, an air based vehicle or any combination thereof). A first end 404 of the tether 402 (e.g., the proximal end) may be secured to the tether station 100 and a second end 406 of the tether 402 (e.g., the distal end) may be attached to the craft 12 (e.g., the body assembly 200). It may be preferable that the second end 406 be attached to the body assembly 200 in such a way that it may not become inadvertently disengaged.

In some implementations each tether 402 may be 500 meters long, 1000 meters long, or other lengths.

The lengths of the tethers 402 may be variable or otherwise adjustable, in real time or otherwise. In one example, the tether station 401 and/or the craft 12 may include mechanisms such as spools that the tethers 402 may be wound upon. The spools may unwind the tethers 402 to extend the length of the tethers 402, and wind the tethers 402 to reduce the length of the tethers 402. This may be controlled by the control system 500. The system 10 may also use other mechanisms or means of extending or reducing the length of the tethers 402 in real time or otherwise.

It may be preferable that each tether 402 extending to each craft 12 may include, without limitation:

1. At least one support tether 408;

2. At least one control line 410;

3. At least one power line 412; and/or

4. At least one water line 414.

Other types of lines, tethers or structures may also be included as required by the system 10. It may be preferable that each tether 402 include at least one support tether 408, at least one control line 410, at least one power line 412 and at least one water line 414. However, it is understood that this may not be required and that each craft 12 may include only one or more of a support tether 408, a control line 410, a control line 412, a water line 414 or any other elements.

Each support tether 408 may include a cord, cable, rope, line, wire or other type of support tether 408 of sufficient strength that may adequately physically tether the crafts 12 to the tether station(s) 401, and/or hold the crafts 12 without breaking. It may be preferable that the support tethers 408 may withstand the forces that may be applied to it from the crafts 12, the tether station 12, the water that may emit from the craft 12 (see below), weather elements, and/or any other forces.

Each control line 410 may be any type of communications transmission line that may transmit signals to and from the crafts 12. The control line 410 may be a cable, wire, coaxial cable, optical fiber, network cable, twisted pair, or any other type of communications line. The control line 410 may transmit any type of signal, communication or protocol, including but not limited to: digital signals, analog signals, modulated signals, IR signals, optical signals, acoustic signals, or any other types of signals. The control lines 410 may also transmit signals at any frequency or combinations of any frequencies. The control lines 410 may carry signals from the control system 500 to the crafts 12, and signals from the crafts 12 to the control system 500 as will be described in other sections. Note that the crafts 12 may also be controlled using wireless signals such as radio frequency (RF), microwave, millimeter wave, IR, or any other type of wireless signals, communications, protocols or methods. In this case, the crafts 12 may or may not require the control lines 410.

Each power line 412 may include a power transmission line of any kind that may deliver power from a power source(s) to the crafts 12. The power source may be included in the tether station 401 or elsewhere. It may be preferable that the power transmitted through the power lines 412 may be sufficient to power all of the required functionalities of the crafts 12 and the associated payloads 302, and that the power lines 412 may be able to withstand the transmission of the required power. The power may be AC, DC, any combination thereof, or any other kind of power. The delivered power may provide power to, without limitation: the propulsion motor(s), the communications receiver, the communications transmitter, the lights 304, the water delivery devices 306, wireless power receiving systems 308, sound devices 310, sound cancellation devices 312, and other types of payloads and any other component or element that may require power. In this way, the crafts 12 may not be required to carry an onboard power supply such as a battery. Given that onboard power supplies may be heavy, removing the need to carry an onboard power supply may allow the crafts 12 to more easily maneuver, to carry other payloads instead, to require less energy to fly, to have longer flights as well as other benefits.

Each water line 414 may carry or otherwise provide water (or any other liquids) to the crafts 12. The water may then be shot, sprayed or otherwise released by the crafts 12 via the water delivery devices 306 that the crafts 12 may include. To this end, a water line 414 may be connected to a source of pressurized air, which when released, may create a water shot, such as in a Shooter® device. It may be preferable that the water lines 414 be adequately flexible so that the water lines 414 may not interfere with the movements and flights of the crafts 12. It may also be preferable that the water lines 414 had adequate diameters so that the lines 414 may deliver an adequate volume of water to the crafts 12 as required by the system 10. The diameter of the water lines 414 need not be uniform along the lengths of the water lines. It may also be preferable that the water lines 414 (when filled with water) be sufficiently lightweight so that the water lines 414 (filled with water) may not create significant drag on the crafts 12 or otherwise compromise their flight. For example, the water lines 414 may comprise polyurethane or other types of polymers or materials.

The water lines 414 may include one or more water delivery devices 416 (e.g., perforations, holes, nozzles or other types of water delivery devices) along the length of each line 414 that may spray, shoot or otherwise release water. The water delivery devices 416 may be located at intervals along the length of the lines 414 at any spacings. It is understood that not each line 414 may be required to include the water delivery devices 416. It is also understood that different crafts 12 may include different types and/or numbers of water delivery devices 416, and at different intervals and/or locations along the lines 414, and that the types, numbers and intervals of water delivery devices 416 need not match. The water delivery devices 416 may be passive devices or active devices, and may be controlled by the control system 400 via the control lines 410, or by any other controller or method.

Portions or the entire lengths of at least some of the water lines 414 may be transparent or opaque, and may include water line lights 418 that may illuminate the water lines 414. In this way, the water lines 414 may also act as glowing light lines. The water line lights 418 may be positioned to launch light into the inner cavity of the lines 414 such that the lights 418 may illuminate the lines 414 from the inside. In one preferred implementation, the lights 418 may be LEDs configured with optical fibers that may transmit the light into the ends of the water lines 414. The lights 418 may be configured with the tether station 401 to shine light into the proximal end of the water lines 414, or may be configured with the crafts 12 to shine light into the distal end of the water lines 414. The lights 418 may transmit white light, colored light or any combination thereof.

It is understood by a person of ordinary skill in the art that the crafts 12 may or may not be configured with the tether system 400, and in such case, may not be tethered to the tether station 401.

### Control System

In one exemplary embodiment hereof, the system 10 may include a control system 500. The control system 500 may include any type of controller(s) 502, including but not limited to, one or more computers, servers, laptops, smartphones, mobile devices, tablet computers or any other type of controller or combinations of controllers. The controller(s) 502 may include CPUs, microprocessors, microcontrollers, memory, communication interfaces (e.g. Wi-Fi, wireless, RFID, LAN, WAN, and any other type of communication interfaces for any other communication protocols or combinations of communication protocols), batteries (preferably rechargeable) or other types of power supplies, software, scripts, applications, and any other components, elements or mechanisms that may be necessary for the control system 500 to adequately perform its functionalities. The control system 500 may be a backend system (also referred to as a cloud platform)

To control the elements of the system 10, the control system 500 may be hard wired to elements of the system 10, wirelessly connected to elements of the system 10, or any combination thereof. It may also be preferable that the control system 500 communicate with the elements of the system 10 over a network such as the Internet, a LAN, a WAN, or any other type of network (wired and/or wireless).

The control system 500 may perform at least some of the following functionalities, without limitation:

1. Control the flight patterns of each craft 12. The flight patterns of each craft 12 may be choreographed and synchronized with other crafts 12 as well as with elements of other structures, crafts and/or displays (e.g., nearby water displays, UASs that may not be a part of the system 10, etc.). For example, the flight patterns of the crafts 12 may be choreographed and synchronized with water streams emitting from ground based water displays, from air based water displays (e.g., from UASs or other crafts 12 emitting water streams of any kind) or any combination thereof.

3. Control each UAS's payload device(s):
a. Water delivery devices 306. This control may include controlling the On/Off of the water devices 306, the orientation, the angle, the shooting direction, the nozzle aperture size, the flow rate of the water into and/or out of the water delivery device 306 and other aspects of the water delivery devices 306.
b. Lighting 304. This control may include controlling the On/Off of the lights 304, the orientation, the angle, the direction, the intensity, the color and other aspects of the lights 304. The lights 304 may be controlled to shine light onto the water streams that may emit from the craft's water delivery devices 306, other crafts 12, water streams that may emit from other crafts' water delivery devices 306, other displays (e.g., water displays and their associated water streams that may not be a part of the system 10), other structures, other crafts, or any other targets.
c. Sound devices 310. This control may include all aspects of the sound or audio that may be emitted by the sound devices 310, including but not limited to, the type of sound or audio (e.g., music, sound effects, etc.), the volume, the direction, the balance between the frequency components of the sound (e.g., equalization), and other aspects of the sound.
d. Sound canceling devices 312. This control may include all aspects of the sound cancelling devices 312 such as the microphone, the real time calculation of the vectorized cancelling audio, the production of the sound cancelling audio and other aspects of the sound cancelling devices 312. The sound cancelling devices 312 may cancel out some or all of the sound produced by the UASs' propulsion systems (the rotor blades).

4. Control the water line lighting 418. This control may include the On/Off control of the lighting 418, the orientation, the angle, the direction, the intensity, the color and other aspects of the lighting 418.

5. Control the flow rate, velocity and water pressure of the water flowing through the water lines 414 and to the crafts 12.

6. Control the water line water delivery devices 416. This control may include controlling the On/Off of the water devices 416, the orientation, the angle, the shooting direction and timing of the release of air other pressure to create a water shot, the nozzle aperture size, the flow rate of the water into and/or out of the water delivery device 416 and other aspects of the water delivery devices 416.

The control system 500 may provide fully automated control, manual control, or any combination thereof. The control system 500 may also control other aspects and elements of the system 10 as required by the system 10. For example, the control system 500 may include craft anti-collision systems that may use real time positional data of each craft 12 and data regarding the choreographed flight paths of each craft 12, to control the crafts 12 in such a way as to ensure that none of the crafts 12 collide with each other or with any other elements (e.g., tethers 402), structures, other flying vehicles such as UASs, etc. The crafts 12 may also include GPS systems and the control system 500 may receive and utilize data from the GPS systems to determine the positions of the crafts 12.

### In Operation

As described in other sections, the system 10 according to exemplary embodiments hereof may include a wheel assembly 100, a body assembly 200, a payload assembly 300, a tether system 400, a control system 500, a power system 600 and other systems, elements, mechanisms and components that may be required by the system 10.

Further aspects of the system 10 including its method and operation will now be described by way of examples of the system 10 in operation.

In one exemplary implementation, the system 10 may be deployed in an indoor structure such as a sports arena, a high ceiling shopping mall or other type of indoor open space. The wheels 102 of the craft 12 may be somewhat large (e.g., 50 feet in diameter) and may include lights of different colors encircling and outlining the wheels' outer circumference. The lights may flash and change colors as the wheels 102 may rotate. In this way, the craft 12 may appear as a flying Ferris wheel to spectators on the ground.

The craft 12 may also include lights 304 configured to the outer circumferences of the wheels 102 that may shine outward. This may give the appearance of a shooting laser beams emanating from an alien craft. The craft 12 may also play music, sound effects or narrate a story.

In another exemplary implementation, the system 10 may be deployed in an outdoor area, and may be configured to complement other structures and/or displays such as water displays. The craft 12 may utilize its lights 304 to illuminate water streams that may emanate from an adjacent water display. The craft 12 may also receive water from the water display, pumped through its water lines 314, and released as water streams or droplets from its water delivery devices 306. In this way, the system 10 may enhance the water display by adding an element of flying water streams.

In another exemplary implementation, the system 10 may be incorporated with other flying crafts such as drones and/or unmanned aircraft systems (UASs). In this example, the craft 12 may be choreographed and synchronized with the flights of the drones/UASs. For instance, the drones/UASs may fly around the craft 12 as the craft 12 shines its lights on the drones/UASs. One or more of the drones/UASs may be tethered or otherwise configured with the craft 12 to provide additional lift to the craft 12, to steer the craft 12, or to otherwise affect the flight of the craft 12.

It is appreciated that the system 10 may be utilized with different displays and/or events at different times. The system 10 may be portable such that it may be easily added and/or retrofitted with the different displays and/or events. Accordingly, the system 10 may be reprogrammable so that the choreography and/or control of the elements of the system 10 may be changed, edited, amended, revised or otherwise programmed at any time depending on its implementation. The system 10 may also be incorporated with the other displays and/or events upon their initial construction or implementation.

In any of the embodiments described or otherwise, the water lines 314 may be illuminated by their associated water line lighting 318 to create the appearance of glowing tentacles.

In any of the embodiments described or otherwise, the sound systems 310 may play music, sound effects (e.g., the sound of thunder or falling rain), narration (e.g., storytelling) or any other types of audio or sound.

In any of the embodiments described or otherwise, the sound cancellation devices 312 may be employed to remove, reduce or otherwise minimize the sound created by the craft's propulsion systems (motor 114, rotating rotors 108-1, 108-2, etc.). Each sound cancellation device 312 may include all of the devices, equipment, software, algorithms and other elements necessary to monitor/sample the sound that may be emitted from its associated craft 12, vectorially calculate the sound and phase of sound that may cancel at least a portion of the emitted sound, and transmit the sound at the proper time, location and phase to cancel the desired emitted sound from the craft 12.

In any of the embodiments described or otherwise, the crafts 12 may include passive acoustic insulation materials and/or structures that may dampen or otherwise reduce the sound that may emit from the crafts 12. This sound may be primarily due to the crafts' motors and rotating rotor blades. The acoustic insulation materials may include graphite foam or other types or combinations of types of sound insulation material. The insulation may be formed as anechoic cones, wedges, pyramids or other shapes that may reduce the emitted sound from the crafts 12. The acoustic insulation material and/or shapes may be positioned on and/or within the crafts 12 in positions that may generally absorb, dampen or otherwise reduce sound emitting from the crafts 12.

In any of the embodiments described or otherwise, water may be provided to the system 10 by a water source or supply such as a water display, a pool, a pond, a lake, the ocean, a reservoir, a water tank or any other type of water supply or combinations of water supplies. The water may be fresh water, salt water, or any combination thereof. The water may be pumped upward through the water line 314 using any type of pump and may be provided to the crafts 12. The water may then be released (as streams, droplets, etc.) by the water delivery devices 306, 316. The exit velocity of the water streams emanating from water delivery devices 306, 316 may also be varied, programmable or otherwise, by varying the water flow and/or pressure into the devices 306, 316. Water flow and pressure may be controlled by the control system 500. The variation in water flow and pressure may be affected by, e.g., varying the rotational speed of the water pump via a variable frequency drive. Alternatively, other types of flow control, such as variable or programmable valves, may be located in the path between the water source and the water delivery devices 306, 316.

In any of the embodiments described or otherwise, any aspects of one or more of the crafts 12 may be powered by wireless power transmission systems. For example, the propulsion system (e.g., the motors), the lights, the water delivery devices, the receiver, the transmitter, the sound systems, the sound cancellation systems, or any other systems and/or components of the crafts 12 may be powered using wireless power transmission systems. The crafts 12 may include the devices necessary to receive the wireless power and convert it to electricity. For example, the crafts 12 may include rectennas to collect the wireless power, rectification circuits to convert the AC to DC, collectors to feed the electricity to the systems to be powered, as well as any other devices, components or elements that may be required. The power system 600 may include the power supplies and the transmitters (e.g., microwave power transmitters) to transmit the wireless power to the crafts 12.

It is understood by a person of ordinary skill in the art, upon reading this specification, that any aspects (alone or in combination) of the embodiments, described or otherwise, of the wheel assemblies 100, the body assemblies 200, the payload assemblies 300, the tether system 400, the control system 400, the power system 600, and any other elements of the system 10, may be combined in any way.

It is understood that the drawings in the figures are meant to represent the different elements of the system 10 as described in the specification and that the size of the elements are not to scale. In addition, the location of the elements depicted may not represent the location of the elements with respect to the other elements.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. An aircraft system, comprising:
at least one rotating wheel with a center and an outer body;
at least one rotor blade configured between the center and the outer body;
at least one source of mechanical energy providing rotation to the at least one rotating wheel;
wherein the at least one rotating wheel rotates providing lift and gyroscopic precession to the aircraft system.

2. The aircraft system of claim 1 further comprising:
at least one compartment configured with the at least one rotating wheel.

3. The aircraft system of claim 2 wherein the at least one compartment includes lighter-than-air gasses.
